(19) United States
(12) Patent Application Publication
(10) Pub. No.: US 2019/0325667 A1
(43) Pub. Date: Oct. 24, 2019

(54) VEHICLE-RELATED DATA COLLECTING APPARATUS AND METHOD

(71) Applicant: N3N CO., LTD., Seoul (KR)

(72) Inventors: Dae Hee KIM, Seoul (KR); Dong Min SEO, Yongin-si (KR); Hye Yong OH, Seoul (KR)

(21) Appl. No.: 16/386,263

(22) Filed: Apr. 17, 2019

(30) Foreign Application Priority Data
Apr. 18, 2018 (KR) 10-2018-0045134

(51) Int. Cl. G07C 5/00; G07C 5/08; G06K 9/00; H04L 29/06

(52) U.S. Cl. CPC G07C 5/008; H04L 29/0651; G06K 9/00791; G07C 5/085

(57) ABSTRACT

A method for collecting vehicle-related data is disclosed. The method includes: obtaining navigation streaming video data related to a vehicle operation and vehicle operation information from a first terminal handling vehicle operation information; encoding in real time the navigation streaming video data, which is received from the first terminal via a wired or wireless network, by an encoder; and synchronizing and storing the real-time encoded navigation streaming video data and vehicle operation information based on time information.

### CROSS-REFERENCE TO RELATED APPLICATIONS

This application claims the benefit of priority of Korean Patent Application No. 10-2018-0045134 filed on Apr. 18, 2018, all of which are incorporated by reference in their entirety herein.

### BACKGROUND OF THE INVENTION

### Field of the Invention

The present invention relates to a data collecting and transmitting apparatus and method and, more particularly, to an apparatus and method for collecting and storing in an environment where a vehicle is moving.

This application is one of the results of Data Hub Center and Urban Administration Service Advancement Technology Research and Development of Korea Agency for Infrastructure Technology Advancement (KAIA) 2018 Smart City Project.

### Related Art

With regard to methods of collecting vehicle-related data, there is a conventionally used method in which vehicle-related data collecting apparatuses individually collect and store images, voice, and structure data. For example, a vehicle is equipped with a navigation terminal, a black box terminal, and other various types of image sensors, in which case the navigation terminal handles data related to the vehicle's operation, the black box handles front- and rear-facing images of the vehicle in operation, and the various types of vehicle-mounted image sensors individually obtain image data related to the vehicle.

However, in a vehicle-moving environment where multiple apparatuses handle data individually, images, voice, and operation information data are stored and used on each apparatus, thus making it difficult to comprehensively analyze data related to the vehicle at the time of an accident. Moreover, there is a likelihood that data might be lost due to damage to the terminals at the time of the accident. This can lead to inefficient use of large amounts of image and non-image data from many terminals and sensors when an actual accident occurs.

### SUMMARY OF THE INVENTION

The present invention provides a vehicle-related data collecting apparatus and method in which each terminal related to a vehicle comprehensively collects streaming video data related to the vehicle operation, other different forms of vehicle operation data, and image data of the vehicle's surroundings and transmits this data to an external terminal.

An exemplary embodiment of the present invention provides a method for collecting vehicle-related data, including: obtaining navigation streaming video data related to a vehicle operation and vehicle operation information from a first terminal handling vehicle operation information; encoding in real time the navigation streaming video data, which is received from the first terminal via a wired or wireless network, by an encoder; and synchronizing and storing the real-time encoded navigation streaming video data and the vehicle operation information based on time information.

The vehicle-related data collecting method may further include obtaining image data of the vehicle's surroundings from a second terminal capturing the vehicle's surroundings, wherein the storing comprises synchronizing and storing the streaming video data, the vehicle operation information, and the image data of the vehicle's surroundings based on time information.

The vehicle-related data collecting method may further include transmitting the real-time encoded navigation streaming video data, the vehicle operation data, and the image data of the vehicle's surroundings in real time to a third terminal external to the vehicle.

The transmitting of the real-time encoded navigation streaming video data, the vehicle operation data, and the image data of the vehicle's surroundings in real time to the third terminal may include: obtaining image output condition information which is related to the real-time encoded navigation streaming video data and the image data of the vehicle's surroundings; adjusting the resolution of the real-time encoded navigation streaming video data and the resolution of the image data of the vehicle's surroundings based on the obtained image output condition information; and transmitting the real-time encoded navigation streaming video data and the image data of the vehicle's surroundings with the adjusted resolutions to the third terminal.

The adjusting of the resolution of the real-time encoded navigation streaming video data and the resolution of the image data of the vehicle's surroundings based on the obtained image output condition information may include determining the resolution of the real-time encoded navigation streaming video data and the resolution of the image data of the vehicle's surroundings in such a way as to keep the bandwidth for data transmission to the third terminal to a minimum, while maintaining a first reference resolution for the navigation streaming video data encoded in real time by the encoder and a second reference resolution for the image data of the vehicle's surroundings according to the image output conditions.

The synchronizing and storing of the navigation streaming video data, the vehicle operation data, and the image data of the vehicle's surroundings based on time information may include: partially storing the real-time encoded navigation streaming data, the vehicle operation data, and the image data of the vehicle's surroundings in a queue; relaying the real-time encoded navigation streaming video data, the vehicle operation data, and the image data of the vehicle's surroundings to the third terminal; and switching the operation mode between a relay mode and a recording mode, the relay mode being a mode in which the real-time encoded navigation streaming data, the vehicle operation data, and the image data of the vehicle's surroundings are relayed to the third terminal based on status reports periodically received from the third terminal, and the recording mode being a mode in which the real-time encoded navigation streaming data, the vehicle operation data, and the image data of the vehicle's surroundings are stored in local storage.

The switching of the operation mode may include switching the operation mode such that the real-time encoded navigation streaming data, the vehicle operation data, and the image data of the vehicle's surroundings, which are buffered in a queue with respect to a non-response point after which there is no status report from the third terminal, are stored in the local storage.

The switching of the operation mode may include: periodically receiving status reports from the third terminal; calculating the average time it takes to receive a report by measuring the time of receipt of a report from the third terminal; determining whether a recording failure has occurred or not by comparing the time it takes to receive a status report from the third terminal to a threshold time; and switching to the relay mode or the recording mode based on the result of determination, wherein the determination of whether a failure has occurred is based on a status report delay which is measured by taking into account either one or both of the measured average time it takes to receive a report and the maximum buffer time.

The first terminal may include a navigation terminal, and the second terminal comprises a black box terminal.

The vehicle-related data collecting method may further include obtaining assistance image data related to vehicle parking from an image sensor, wherein the navigation streaming video data, the vehicle operation data, the image data of the vehicle's surroundings, and the assistance image data are synchronized and stored based on time information.

Another exemplary embodiment of the present invention provides an apparatus for collecting vehicle-related data, including: an encoder that obtains navigation streaming video data related to a vehicle's operation and vehicle operation information from a first terminal handling vehicle operation information via a wired or wireless network and encodes the navigation streaming video data in real time; a controller that performs control functions for synchronizing the real-time encoded navigation streaming video data and the vehicle operation information based on time information and storing the same in local storage; and local storage that stores the real-time encoded navigation streaming video data and the vehicle operation information.

The controller may obtain image data of the vehicle's surroundings from a second terminal capturing the vehicle's surroundings, wherein the controller synchronizes the streaming video data, the vehicle operation information, and the image data of the vehicle's surroundings based on time information and stores the same in the local storage.

The vehicle-related data collecting apparatus may further include a communication unit for transmitting the real-time encoded navigation streaming video data, the vehicle operation information, and the image data of the vehicle's surroundings in real time to a third terminal external to the vehicle.

The controller may perform control functions for: obtaining image output condition information which is related to the real-time encoded navigation streaming video data and the image data of the vehicle's surroundings; adjusting the resolution of the real-time encoded navigation streaming video data and the resolution of the image data of the vehicle's surroundings based on the obtained image output condition information; and transmitting the real-time encoded navigation streaming video data and the image data of the vehicle's surroundings with the adjusted resolutions to the third terminal.

The controller may determine the resolution of the real-time encoded navigation streaming video data and the resolution of the image data of the vehicle's surroundings in such a way as to keep the bandwidth for data transmission to the third terminal to a minimum, while maintaining a first reference resolution for the navigation streaming video data encoded in real time by the encoder and a second reference resolution for the image data of the vehicle's surroundings according to the image output conditions.

The controller may perform control functions for: partially storing the real-time encoded navigation streaming data, the vehicle operation information, and the image data of the vehicle's surroundings in a queue; relaying the real-time encoded navigation streaming video data, the vehicle operation information, and the image data of the vehicle's surroundings to the third terminal; and switching the operation mode between a relay mode and a recording mode, the relay mode being a mode in which the real-time encoded navigation streaming data, the vehicle operation information, and the image data of the vehicle's surroundings are relayed to the third terminal based on status reports periodically received from the third terminal, and the recording mode being a mode in which the real-time encoded navigation streaming data, the vehicle operation information, and the image data of the vehicle's surroundings are stored in local storage.

The controller may perform control functions for switching the operation mode such that the real-time encoded navigation streaming data, the vehicle operation information, and the image data of the vehicle's surroundings, which are buffered in a queue with respect to a non-response point after which there is no status report from the third terminal, are stored in the local storage.

The switching of the operation mode by the controller may be done by periodically receiving status reports from the third terminal, calculating the average time it takes to receive a report by measuring the time of receipt of a report from the third terminal, determining whether a recording failure has occurred or not by comparing the time it takes to receive a status report from the third terminal to a threshold time, and switching to the relay mode or the recording mode based on the result of determination, wherein the determination of whether a failure has occurred is based on a status report delay which is measured by taking into account either one or both of the measured average time it takes to receive a report and the maximum buffer time.

The first terminal may include a navigation terminal, and the second terminal comprises a black box terminal.

The controller may obtain assistance image data related to vehicle parking from an image sensor, wherein the navigation streaming video data, the vehicle operation information, the image data of the vehicle's surroundings, and the assistance image data are synchronized and stored based on time information.

Yet another exemplary embodiment of the present invention provides a system for collecting vehicle-related data, including: a vehicle-related data collecting apparatus that obtains navigation streaming video data related to a vehicle operation and vehicle operation information from a first terminal handling vehicle operation information, encodes in real time the navigation streaming video data, which is received from the first terminal, and synchronizes the real-time encoded navigation streaming video data and the vehicle operation information based on time information and transmits the same to a third terminal external to the vehicle; and a third terminal that receives the real-time encoded navigation streaming video data and the vehicle operation information from the vehicle-related data collecting apparatus and stores the same.

### BRIEF DESCRIPTION OF THE DRAWINGS

FIG. 1 is a block diagram schematically showing a system including a vehicle data collecting apparatus according to an exemplary embodiment of the present invention.

FIG. 2 is a conceptual diagram for explaining a method in which a vehicle data collecting apparatus according to an exemplary embodiment of the present invention synchronizes and stores vehicle-related data based on time information.

FIG. 3 is a detailed block diagram showing in detail an encoder of a vehicle data collecting apparatus according to an exemplary embodiment of the present invention.

FIG. 4 is a detailed block diagram showing in detail an encoding unit of a vehicle data collecting apparatus according to an exemplary embodiment of the present invention.

FIG. 5 is a conceptual diagram showing a POD (Pixel On-Demand) method used by an image distributor of a vehicle data collecting apparatus according to an exemplary embodiment of the present invention.

FIG. 6 is a view showing an exemplary screen where a third terminal external to the vehicle uses data it receives from a vehicle data collecting apparatus according to an exemplary embodiment of the present invention.

FIG. 7 is a conceptual diagram schematically showing a system for double recording based on a vehicle data collecting apparatus according to another exemplary embodiment of the present invention.

FIG. 8 is a detailed block diagram showing in detail the configuration of a vehicle data collecting apparatus for performing double recording according to another exemplary embodiment of the present invention.

FIG. 9 is a flowchart showing a method for determining whether a failure has occurred by the switching unit of FIG. 8.

### DESCRIPTION OF EXEMPLARY EMBODIMENTS

The present invention may be subjected to many changes and have several forms, and specific embodiments thereof are illustrated in the drawings and described in detail in the specification.

However, it will be understood that the present invention is not intended to be limited to the specific forms set forth herein, and all changes, equivalents, and substitutions included in the technical scope and spirit of the present invention are included.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting of the inventive subject matter. It will be further understood that the terms “includes,” “comprises,” “including” and/or “comprising,” when used in this specification, specify the presence of stated features, numbers, steps, operations, elements, components, and/or combinations thereof, but do not preclude the presence or addition of one or more other features, numbers, steps, operations, elements, components, and/or combinations thereof.

Unless otherwise defined, all terms (including technical and scientific terms) used herein have the same meaning as commonly understood by one of ordinary skill in the art to which this inventive subject matter belongs. It will be further understood that terms, such as those defined in commonly used dictionaries, should be interpreted as having a meaning that is consistent with their meaning in the context of the specification and the relevant art and will not be interpreted in an idealized or overly formal sense unless expressly so defined herein.

Hereinafter, embodiments of the present disclosure will be described in greater detail with reference to the accompanying drawings. In order to facilitate general understanding in describing the present disclosure, the same components in the drawings are denoted with the same reference numerals, and repeated description thereof will be omitted.

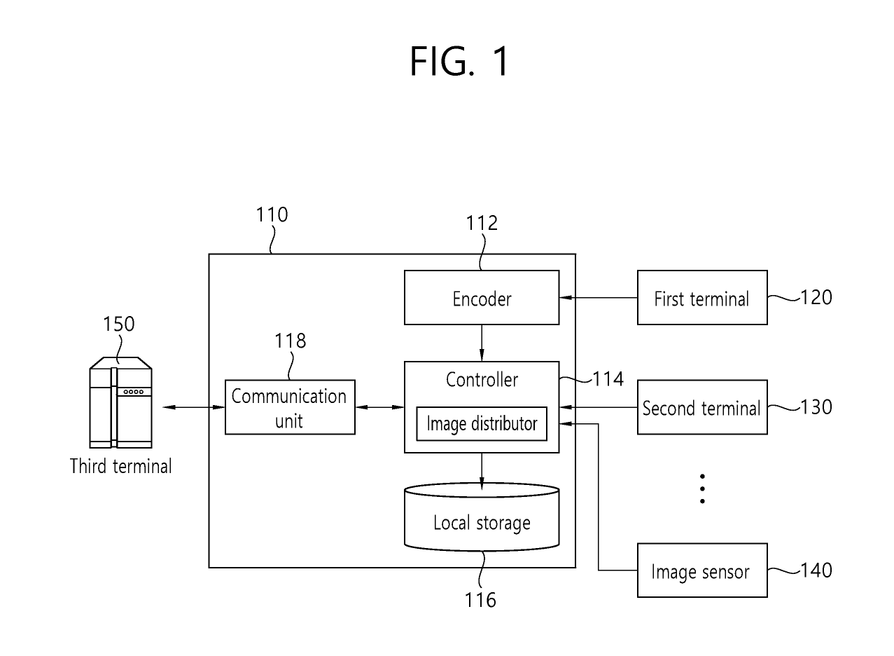

FIG. 1 is a block diagram schematically showing a system including a vehicle data collecting apparatus according to an exemplary embodiment of the present invention. As shown in FIG. 1, the system including a vehicle data collecting apparatus according to an exemplary embodiment of the present invention may include a vehicle data collecting apparatus 100, a first terminal 120, a second terminal 130, an image sensor 140, and a third terminal 150.

Referring to FIG. 1, the vehicle data collecting apparatus 110 is a terminal associated with a vehicle, which may be mounted in the vehicle, detachably connected to the vehicle, or physically separated from the vehicle and carried around. The vehicle data collecting apparatus 110 may be called a vehicle-related data collecting apparatus or the like. The vehicle data collecting apparatus 110 may be connected to the first terminal 120, second terminal 130, and image sensor 140 via a wired and/or wireless network.

The first terminal 120 is a terminal that handles data related to the vehicle's operation (vehicle operation information). The first terminal 120 may be a navigation device. The first terminal 120 is capable of obtaining GPS (Global Positioning System) and GIS (Geographic Information System) data related to the vehicle's operation, and may handle time information too. That is, it handles various information about the location where the vehicle is at a specific time (e.g., the present time) and the origin, destination, and route of the vehicle.

The first terminal 120 creates one or more routes most suitable for the current location and an entered destination upon receiving input from the user, and supports the operation of the vehicle based on one of the created routes the user chooses. At this point, the first terminal 120 generates image data related to navigation operation that show the relationship between the created route and the vehicle. Besides, in the vehicle's operation, it may generate structured or unstructured data related to a situation the vehicle is in, including the vehicle's current geographic location, speed, direction of travel, latitude, longitude, nearby buildings (the names of nearby buildings, nearby restaurants, nearby gas stations, etc.). The first terminal 120 then provides navigation video data to an encoder 112 of the vehicle data collecting apparatus 110 in streaming format. At this point, not only images of the vehicle during operation but also screen data the user enters about settings may be provided to the encoder 112 in streaming format. Also, other structured or unstructured data related to the vehicle's operation may be provided to the encoder 112 and/or a controller 114. If the navigation is off, the transmission of image data to the encoder 112 may be stopped. In this case, the encoder 112 may not perform encoding.

The second terminal 130 is a terminal including a camera for capturing images of the vehicle's surroundings. The second terminal 130 may be a black box terminal. A plurality of second terminals 130 may be placed on the front and/or rear of the vehicle and create front- and/or rear-facing images of the vehicle in operation. Also, the second terminal 130 may be placed laterally and create side images of the vehicle or three-dimensional, upward and/or downward images of the vehicle by shooting. Still images of the vehicle may be recorded while parked, as well as images of the vehicle while driving, and images of special situations such as lane departure may be created along with time information. Image data of the vehicle's surroundings generated by the second terminal 130 may be provided to an image distributor 114 of the vehicle data collecting apparatus 110 via a wired and/or wireless network.

Besides, at least one image sensor 140 may be mounted in the vehicle and collect and create images. The image sensor is a device placed on the front, rear, sides, etc. of the vehicle to assist in parking, in addition to the second terminal 130, and may create parking assistance images. The phrase “image sensor 140” does not imply handling images only, but various sensors such as an ultrasonic sensor and a voice sensor may be used. Also, text or numerical data collected from these sensors may be stored in local storage and/or transmitted to the third terminal 150.

The vehicle data collecting apparatus 110 receives at least one image's data and at least one image, voice, and structured and/or unstructured data related to the vehicle's operation from the first terminal 120, second terminal 130, and image sensor 140 and stores them in local storage 116 and/or provides them to the third terminal 150 external to it through a communication unit 118.

The vehicle data collecting apparatus 110 may include the encoder 112, the controller 114, local storage 116, and the communication unit 118.

The encoder 112 receives navigation streaming video data in real time from the first terminal 120 and encodes it. The encoder 112 may be connected to the first terminal 120 via wire or wirelessly. When connected via wire, the encoder 112 may be connected through a digital interface such as HDMI (High-Definition Multimedia Interface) or DVI (Digital Visual Interface). When the encoder 112 is connected to the first terminal 120 through a digital interface, the first terminal 120 may detect the connection with the encoder 112 and provide display screen data (e.g., image data outputted from the navigation) in real time to the encoder 112. At this point, it is preferable that a driver associated with the encoder 112 is installed on the first terminal 120 to detect the encoder 112. Moreover, the encoder 112 may be supported to receive control commands from the outside and control the first terminal 120. For example, if navigation streaming video data of the first terminal 120 is transmitted in real time to the user of the third terminal 150 which is an external terminal, the user of the third terminal 150 or a user connected to the third terminal 150 may provide control commands on the first terminal 120 to the vehicle data collecting apparatus 110 while watching navigation video in real time. The control commands then may be provided to the first terminal 120 via the encoder to enable remote control. 1521 The encoder 112 may include an encoding function, a network function, and a computer command interpretation function. The encoder 112 receives display screen data (which may be navigation streaming video data) from the first terminal 120 connected via wire through a digital interface. The encoder 112 then encodes the received navigation streaming video data in real time and store it in the local storage 116 or provide it to the third terminal 150 through the communication unit 118. At this point, the encoded data is provided to the third terminal 150 through a real-time communication protocol (RTP or RTSP) so that the user of the third terminal 150 gives a control command from a remote location immediately upon viewing the data.

The encoder 112 provides a screen encoded by it to a bypass monitor (not shown) so that the user of the vehicle data collecting apparatus 110 may view image data transmitted in real time by the encoder 112 on the bypass monitor. The bypass monitor includes a terminal capable of displaying that is connected through a wired and/or wireless network. Moreover, the encoder 112's encoding, network, and/or system settings screen may be provided to the bypass monitor so that the user of the encoder 112 may change the encoder 112's setting data through a user interface (e.g., keyboard, mouse, touchpad, etc.) (not shown) connected to the encoder 112. The encoder 112 provides structured and/or unstructured data related to the vehicle's operation, apart from the navigation streaming video data received from the first terminal 120, to the controller 114.

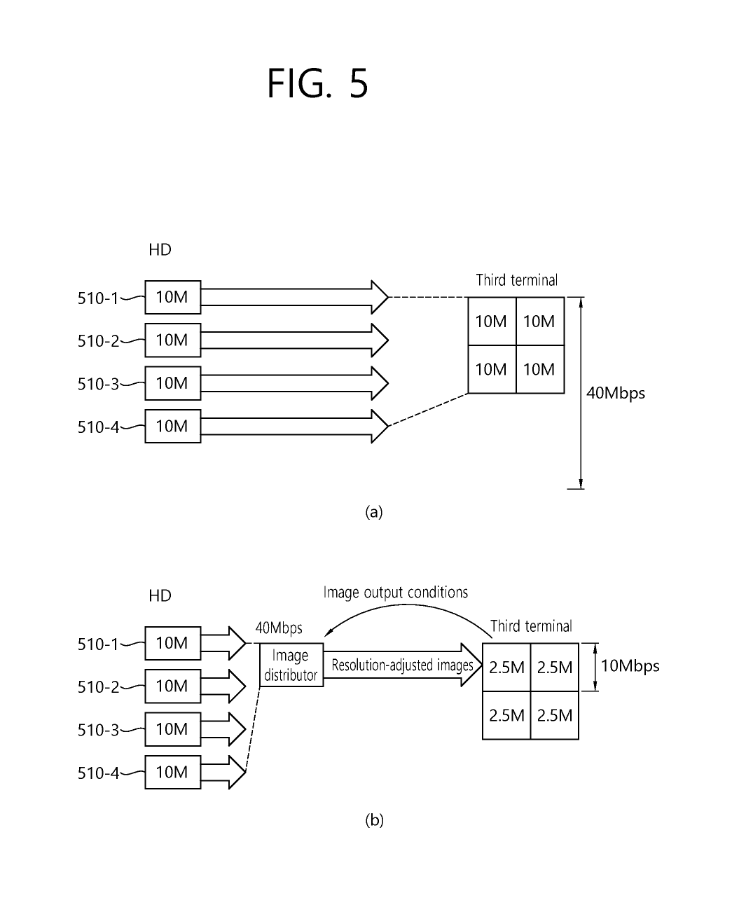

The controller 114 performs a function for distributing image data, and stores collected data about the vehicle's operation in the local storage 116. Here, the function for distributing image data may be performed by an image distributor in the controller 114. The image distributor is a distributor (also called a media distributor (MD)) that controls the distribution of collected images. The image distributor may function like a server. As for images collected through a plurality of ports, the image distributor serves to distribute and provide the images in the most suitable form for image output condition information by the third terminal 150. This will be described in more details with reference to FIG. 5.

Moreover, the controller 114 synchronizes collected images, voice, and structured/unstructured data related to the vehicle with each other based on time information, and stores the synchronized data in the local storage 116.

In addition, the controller 114 may provide various types of synchronized vehicle-related data to the third terminal 150 through the communication unit 118.

The communication unit 118 is a component including a communication function, which may be implemented by hardware such as an antenna and/or communication processor.

The third terminal 150 receives synchronized vehicle-related data from the vehicle data collecting apparatus 110. Then, it may display the received data through a connected display means (e.g., TV, monitor, or touchscreen). In this case, data of multiple images may be displayed on the display means, and a single physical screen may be logically divided into a number of cells to display different images. At this point, image output condition information may be generated by taking into account the size of the images divided into the cells, and send it to an image distributor of the controller 114 through the communication unit 118. The image distributor may adjust the resolution of image data to be transmitted by taking into account the received image output condition information.

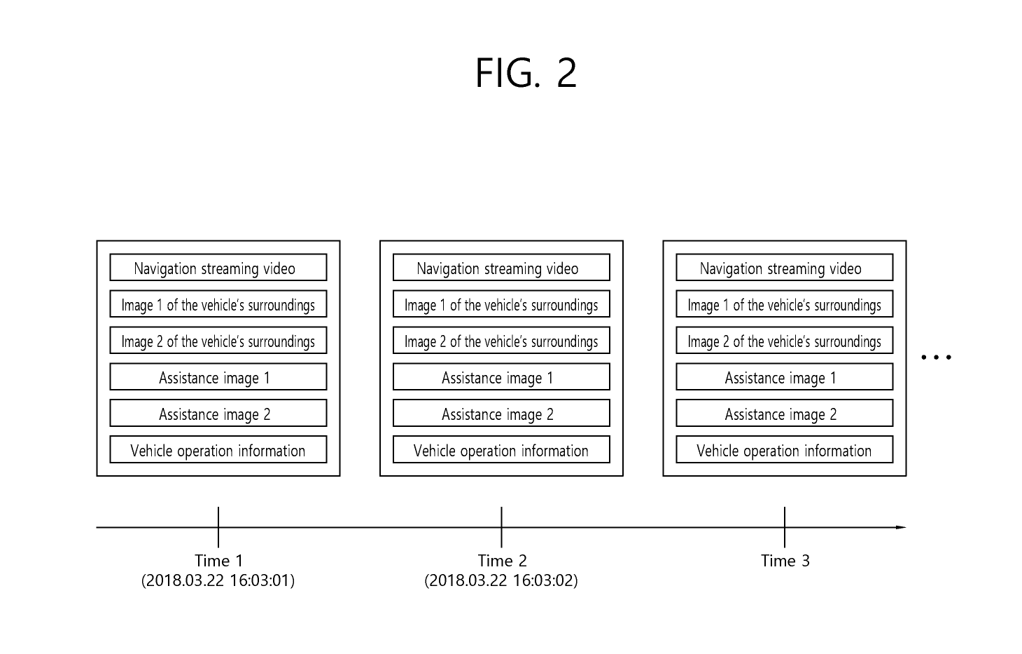

FIG. 2 is a conceptual diagram for explaining a method in which a vehicle data collecting apparatus according to an exemplary embodiment of the present invention synchronizes and stores vehicle-related data based on time information.

Referring to FIG. 2, the controller of the vehicle data collecting apparatus synchronizes collected vehicle-related data based on time information and stores it in local storage. Also, the synchronized vehicle-related data may be provided to the third terminal, with time information such as timestamps inserted into it.

At this point, information stored along with the time information may include navigation streaming video data encoded in real time by the encoder, data of at least one image of the vehicle's surroundings (front- and rear-facing images of the vehicle), assistance image data (the vehicle's side images, vehicle assistance images, vehicle interior images, etc.), vehicle operation information (vehicle location, GPS data, GIS data, speed, direction, route, origin, destination, log data related to destination search, traffic conditions, information about the surroundings, etc.). Such vehicle-related data may be synchronized with time information and stored in the local storage. In this case, the files may be physically stored in the same location or in different locations.

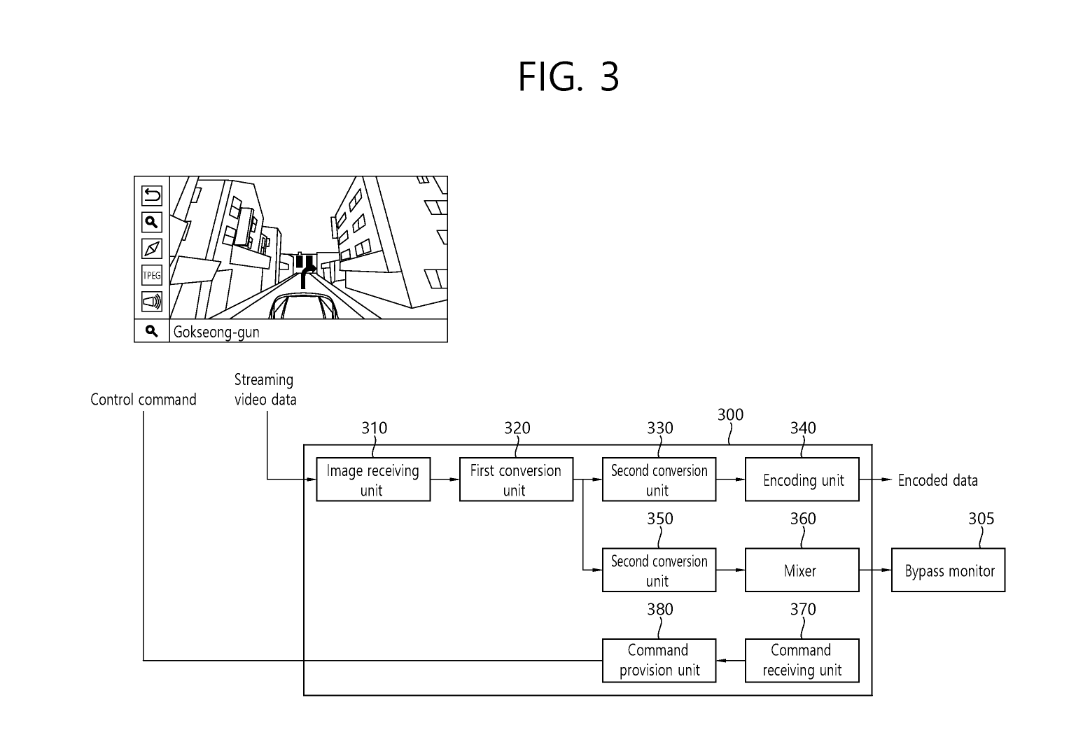

FIG. 3 is a detailed block diagram showing in detail an encoder of a vehicle data collecting apparatus according to an exemplary embodiment of the present invention. As shown in FIG. 3, the encoder according to an exemplary embodiment of the present invention may include an image receiving unit 310, a first conversion unit 320, a second conversion unit 330, an encoding unit 340, a second conversion unit 350, a mixer 360, a command receiving unit 370, and a command provision unit 380.

Referring to FIG. 3, the image receiving unit 310 receives navigation streaming video data from the first terminal. The image receiving unit 310 may receive navigation streaming video data in real time from the first terminal while connected via wire (e.g., digital interface) or wirelessly.

The image receiving unit 310 may use a digital interface such as HDMI/DVI, and convert the received navigation streaming video data into MIPI CSI (Mobile Industry Processor

Interface for Camera Serial Interface) through the digital interface. The MIPI CSI is an interface between the first terminal and a host processor. It complies with standard protocols such as CSI-1, CSI-2, CSI-3, and CSI-4.

The first conversion unit 320 receives MIPI CSI-based navigation streaming video data from the image receiving unit 310 and converts it into a YUV data format. According to the exemplary embodiment of the present invention, the converted YUV data may include YUV 420 data formats. The YUV 420 data formats may include a legacy YUV 420 format for compatibility with the existing systems and a non-legacy YUV 420 format for low-cost implementation. The first conversion unit 320 provides navigation streaming video data in the YUV format to the second conversion units 330 and 350 over two separate channels. At this point, data is transmitted to the controller by encoding over the channel for the second conversion unit 330, and screen data may be provided to a bypass monitor 305 by mixing over the channel for the second conversion unit 350.

The second conversion units 330 and 350 convert the YUV data into RGB data. It is preferable to convert the YUV data into RGB-format data with a low compression rate which consists of red (R), green (G), and blue (B) since the YUV formats may have a high compression rate. The second conversion unit 330 may use at least one of the 4:2:0, 4:2:2, and 4:4:4 conversion methods but is not necessarily limited thereto.

The encoding unit 340 encodes the navigation streaming video data from the first terminal that is converted into RGB format by the second conversion unit 330. Various encoding methods may be used, including HEVC(High Efficiency Video Coding)(H.265), H.264/AVC, SVC(Scalable Video Coding), MVC(Multiview Video Coding), DivX, WMV(Window Media Video), VP8, and VP9. The encoding method may be selected in the user's settings and changed through a user interface. Moreover, the encoding unit 340 may encode data after changing the resolution, frame rate, and/or bit rate through the user's settings. The encoding unit 340 may encode data frame by frame or in frame segments (which are, for example, one fourth of the size of a frame)

The controller transmits the navigation streaming video data from the first terminal encoded by the encoding unit 340 to the third terminal. The controller may receive one complete frame from the encoding unit 340 and then packetize and transmit it to the third terminal. Alternatively, the controller may receive data encoded in frame segments and packetize and transmit it to the third terminal. The encoded data is transmitted to the third terminal through a real-time communication protocol such as RTP or RTSP.

The mixer 360 mixes the RGB-format navigation streaming video data converted by the second conversion unit 350 into a form that displays through a digital interface such as

HDMI/DVI and/or a wireless network. The mixed data is provided to the bypass monitor 305 connected through the digital interface and/or wireless interface.

With a video stream displayed through the mixing process, the bypass monitor 305 may show, to the user of the vehicle data collecting apparatus, a screen processed by the vehicle data collecting apparatus and transmitted to the third terminal, and the user of the vehicle data collecting apparatus may view the screen of the first terminal if the first terminal is currently likely to be remote-controlled, and also may view the navigation screen of the first terminal if the navigation screen is changed via remote control. For example, if the user of the third terminal at a remote location chooses a particular icon by clicking on it, such a change to the screen of the first terminal is displayed on the bypass monitor 305 so that the user of the vehicle data collecting apparatus may perceive the change.

The command receiving unit 370 receives control commands from the third terminal via the controller. These control commands are control commands from a remote location to the first terminal, which the user of the third terminal provides using a user interface (not shown) connected to the third terminal while viewing the screen of the first terminal. They may include move the cursor, click the cursor, enter text/numbers/symbols, enter a command, and so on.

The command provision unit 380 parses a control command received by the command receiving unit 370 and provides it to the first terminal. The first terminal receives the control command and executes the user's command associated with the third terminal.

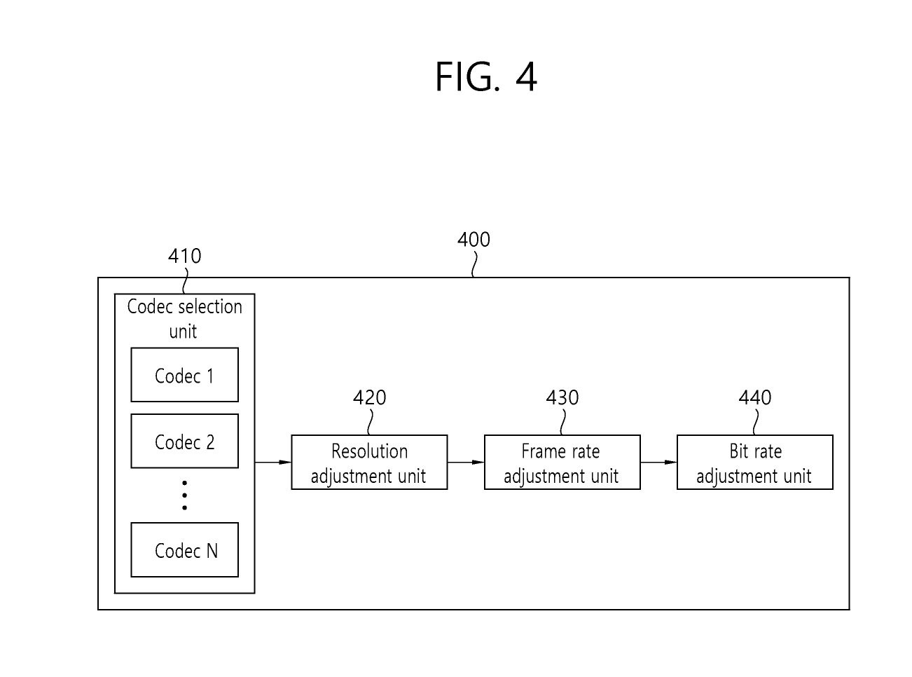

FIG. 4 is a detailed block diagram showing in detail an encoding unit of a vehicle data collecting apparatus according to an exemplary embodiment of the present invention. As shown in FIG. 4, the encoding unit 400 according to an exemplary embodiment of the present invention may include a codec selection unit 410, a resolution adjustment unit 420, a frame rate adjustment unit 430, and a bit rate adjustment unit 440.

Referring to FIG. 4, the codec selection unit 410 selects one from among a plurality codecs (Codec 1, Codec 2, . . . , Codec N). The codec section unit 410 may select one from among a number of codecs depending on the user's settings. The code selection unit 410 is controlled to perform encoding with Codec 1 by default and then perform encoding with Codec 2 if the codec is changed in the user's settings.

The resolution adjustment unit 420 adjusts the resolution of frames in relation to encoding. That is, the fineness of detail that can be represented by encoded data may be adjusted. It may be defined by the number of horizontal pixels and the number of vertical pixels. It can also be set to a default value, which may be changed as the user desires through a user interface. Alternatively, a plurality of modes (3840×2160, 1920×1080, 1280×720, 1024×768, 800×600, 320×180, etc.) may be set, and one of them may be variably selected.

The frame rate adjustment unit 430 adjusts the frame rate in relation to encoding, and the bit rate adjustment unit 440 adjusts the bit rate. The frame rate adjustment unit 430 may provide various frame rates, such as 15, 30, and 60 fps, and may use a given number of fps regardless of resolution. The frame rate and bit rate may be set to a default value as well, and the user may change them as the user desires through a user interface. Frame rate may be defined as the number of frames in a second, and bit rate may be defined as the amount of information per second. The user may effectively adjust the picture quality of navigation video data from the first terminal by adjusting the frame rate and bit rate as desired. That is, when handling high picture quality data according to the characteristics of the first terminal, the user of the vehicle data collecting apparatus may perform encoding after tuning the encoding-related parameters of the vehicle data collecting apparatus to high quality so that even a user at a remote location can watch high picture quality navigation video. On the contrary, when handling relatively low picture quality data, the encoding-related parameters may be tuned to values suitable for low picture quality, thereby improving encoding efficiency.

FIG. 5 is a conceptual diagram showing a POD (Pixel On-Demand) method used by an image distributor of a vehicle data collecting apparatus according to an exemplary embodiment of the present invention.

The figure (a) of FIG. 5 is a conceptual diagram showing that a plurality of images are provided to the third terminal in a general way. In the above figure, Image 1 510-1 may be navigation streaming video data encoded in real time by the encoder, and Image 2 510-2 and Image 3 510-3 may be front- and rear-facing images of the vehicle obtained from the second terminal. Also, Image 4 may be a side image of the vehicle obtained from the image sensor. Each image's data 510-1 to 510-4 has a particular resolution, and may have adequate quality when provided using a bandwidth of 10 Mbps (bit per second). As such, in order for the vehicle data collecting apparatus to transmit to the third terminal Images 1 to 4 510-1 to 510-4 requiring the 10 Mbps bandwidth, a bandwidth of 10 Mbps×4=40 Mbps is needed.

The figure (b) of FIG. 5 is a conceptual diagram for explaining a POD method used by an image distributor of a vehicle data collecting apparatus according to an exemplary embodiment of the present invention. In the figure (b) of FIG. 5, it is assumed that navigation streaming video encoded by the encoder and images of the vehicle's surroundings have a bit rate of 10 Mbps and adequate resolution—as is the case with the figure (a) of FIG. 5. This adequate resolution is a reference resolution for transmission. For navigation streaming video data, the adequate resolution refers to a resolution at which the data is encoded, and, for other image data received by the image distributor without passing through the encoder, the adequate resolution refers to a resolution at which the data is received. The reference resolution may be changed depending on the user's settings. Moreover, it is preferable that the POD method according to an exemplary embodiment of the present invention is not used for non-image data.

In the foregoing embodiment, the image distributor receives all of the input Images 1 to 4 510-1 to 510-4 using a bandwidth of 40 Mbps, and maximizes the efficiency of the transmission bandwidth by properly adjusting the resolution of the received images. The image distributor may obtain image output condition information from the third terminal. The image output condition information is information about the requirements for image output by the third terminal, which includes the number of output images, image identification information, and information about the size and placement of output images. For example, if

Images 1 to 4 510-1 to 510-4 are all outputted and four equal size Images 1 to 4 510-1 to 510-4 are displayed on the third terminal, the identification numbers of the output images and the information about the size of output images corresponding to their identification numbers are provided from the third terminal to the image distributor.

The image distributor may specify an image to be transmitted based on the image identification numbers which are included in the received image output condition information received from the third terminal, and determine the resolution of the specified image based on the information about the size of output images. At this point, the determined resolution may be a resolution that keeps the bandwidth for image transmission to the third terminal to a minimum, while maintaining the original resolution of the images according to the image output conditions for the third terminal. For example, in the exemplary embodiment illustrated in (b) of FIG. 5, four images having a resolution that requires a transmission bandwidth of 10 Mbps are transmitted, but the corresponding images output by the third terminal are one-fourth of the original size. Thus, the image distributor may find it difficult to detect the reduction in the resolution of every image to ¼ on the output screen of the third terminal. In this regard, it is preferable that the four images are transmitted with a bandwidth of 2.5 Mbps×4=10 Mbps, rather than 40 Mbps in total, by adjusting the resolution to ¼ and transmitting the images, not at the bandwidth of 10 Mbps required for each image, but at a bandwidth of 2.5 Mbps. This is how the POD method used in the image distributor of the present invention works.

According to the exemplary embodiment of the present invention, a display means of the third terminal may display images by overlaying them, and therefore even a screen where a plurality of images with the reference resolution of 10 Mbps may need a bandwidth of over 10 Mbps. Also, it is obvious that a bandwidth less than 10 Mbps may be used because there might be no image presented in the entire area of the display means of the third terminal (text, numbers, or other forms of data may be displayed).

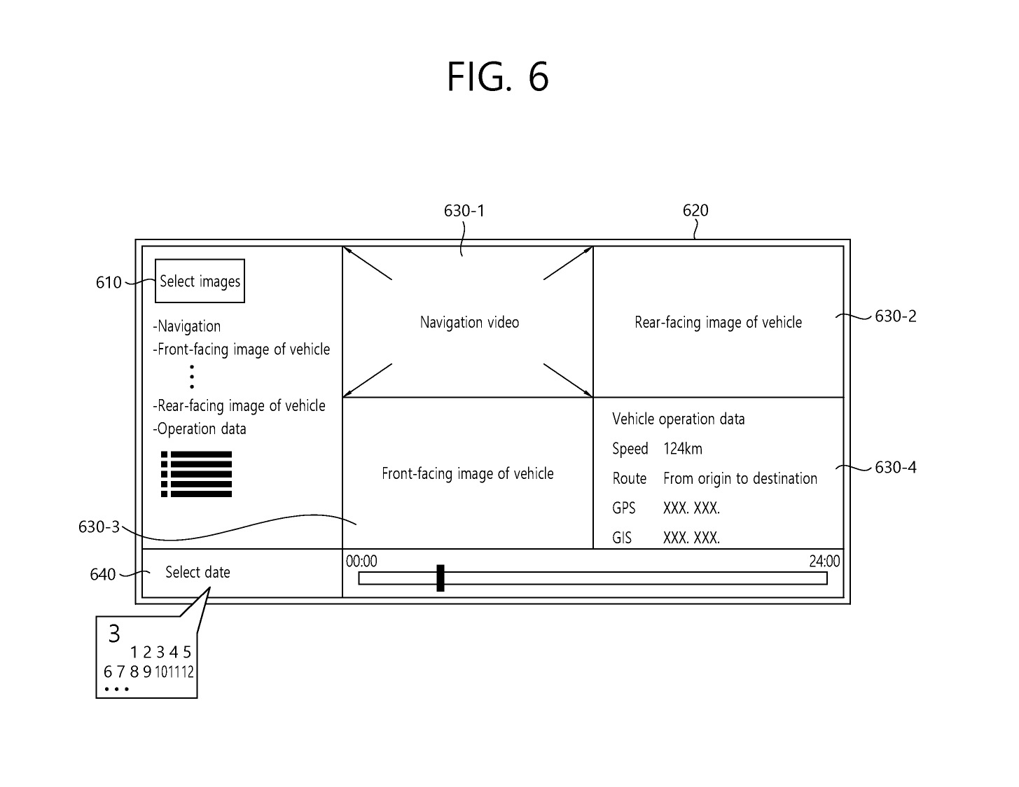

FIG. 6 is a view showing an exemplary screen where a third terminal external to the vehicle uses data it receives from a vehicle data collecting apparatus according to an exemplary embodiment of the present invention.

Referring to FIG. 6, the vehicle data collecting apparatus may store a plurality of images, voice, and structure/unstructured data synchronized based on time information directly in local storage, and later may extract and review them or transmit them for use in real time to the third terminal, which is external to the vehicle.

The data transmitted to the third terminal from the vehicle data collecting apparatus may be used as shown in FIG. 6. That is, a viewer of the vehicle data collecting apparatus may determine which type of image to output through an image selection icon 610. The types of output images correspond to the types of collected images. That is, the types of output images may include navigation streaming video, a front-facing image of the vehicle, a rear-facing image of the vehicle, side-facing images of the vehicle, parking assistance images, and a comprehensive image of vehicle operation information.

In the exemplary embodiment of the present invention, it is assumed that navigation video, the front-facing image of the vehicle, the rear-facing image of the vehicle, and a comprehensive image of vehicle operation data are displayed in four separate cells. One monitor includes a plurality of cells 630-1, 630-2, 630-3, and 630-4, and each cell may output one significant screen. In this case, one physical monitor may be called a canvas 620. That is, the canvas 620 may be divided into a plurality of square or rectangular cells 630-1, 630-2, 630-3, and 630-4.

According to the exemplary embodiment illustrated in FIG. 6, the third terminal displays navigation streaming video in the cell 630-1 of the connected monitor, the rear-facing image of the vehicle in the cell 630-2, the front-facing image of the vehicle in the cell 630-3, and a comprehensive screen of vehicle operation data in the cell 630-4. At this point, the characteristics of the images embedded in the cells and the size of each cell may be set and changed through a user interface (not shown) of the third terminal. Also, the user may change the type of operation data to be displayed on the comprehensive screen of vehicle operation data. For example, vehicle operation data types to be displayed may include at least some of the following: vehicle's speed, GPS/GIS locations, route at a specific time, nearby stores, nearby traffic conditions (including news about accidents), and data related to traffic congestion. Moreover, a stored map and GPS/GIS locations may be synchronized with each other so that the vehicle including the vehicle data collecting apparatus is displayed as an object on the stored map.

In addition, a date selection icon 640 lets the user to choose either past data transmitted to the third terminal or real-time transmitted current data to display it on the screen. When transmitting the real-time transmitted current data on the screen, it is preferable to transmit, in real time, information related to the size of each cell 630-1, 630-2, 630-3, and 630-4 and the characteristics of the image displayed in each cell 630-1, 630-2, 630-3, and 630-4 to the vehicle data collecting apparatus, in relation to the screen's display settings. In this way, the image distributor of the vehicle data collecting apparatus is able to transmit image data tuned to the most suitable resolution by using the POD method.

When transmitting the past data on the screen, data times for all of the cells 630-1, 630-2, 630-3, and 630-4 may be specified. For example, data playback time may be set to a specific date (e.g., 15th) of March in the past, in which case a time bar 650 corresponding to that date may be shown at the bottom of the screen. At this point, by setting a specific point in time using the time bar 650, data corresponding to that point in time is loaded and displayed in the cells 630-1, 630-2, 630-3, and 630-4. That is, if data for 03:15:04 on 15, March is played, the navigation streaming video for 03:15:04 on 15, March may be displayed in the cell 630-1, the rear-facing image of the vehicle for 03:15:04 on 15, March may be displayed in the cell 630-2, the front-facing image of the vehicle for 03:15:04 on 15, March may be displayed in the cell 630-3, and the comprehensive screen of vehicle operation data for 03:15:04 on 15, March may be displayed in the cell 630-4. That is, the user of the third terminal may comprehensively understand how the vehicle is operating at a specific point in time by seeing at a glance various images and voice and structured/unstructured data corresponding to that point in time through the screen. In this case, the third terminal may use an image analysis module (not shown). For example, by analyzing a plurality of images over time by the image analysis module and detecting a specific event based on which stored entries are detected, other images corresponding to points in time related to the detected event are automatically detected and analyzed as well, thereby allowing for efficient analysis of vehicle-related situations.

Also, it will be apparent to those skilled in the art that each cell displays data corresponding to a different specific point in time (for example, the cell 630-1 displays an image corresponding to Time 1 and the cell 630-2 displays an image corresponding to Time 2).

Additionally, the cells may be overlaid on each other—for example, one cell may appear as if it precedes other cells. Images may be overlaid in such a way that navigation streaming video is displayed as if poking out into 3D space and other images are placed underneath it. The placement of overlaid images, the characteristics of images to be embedded in the overlaid cells, and the size of the overlaid cells may be adjusted as well through a user interface as the user desires.

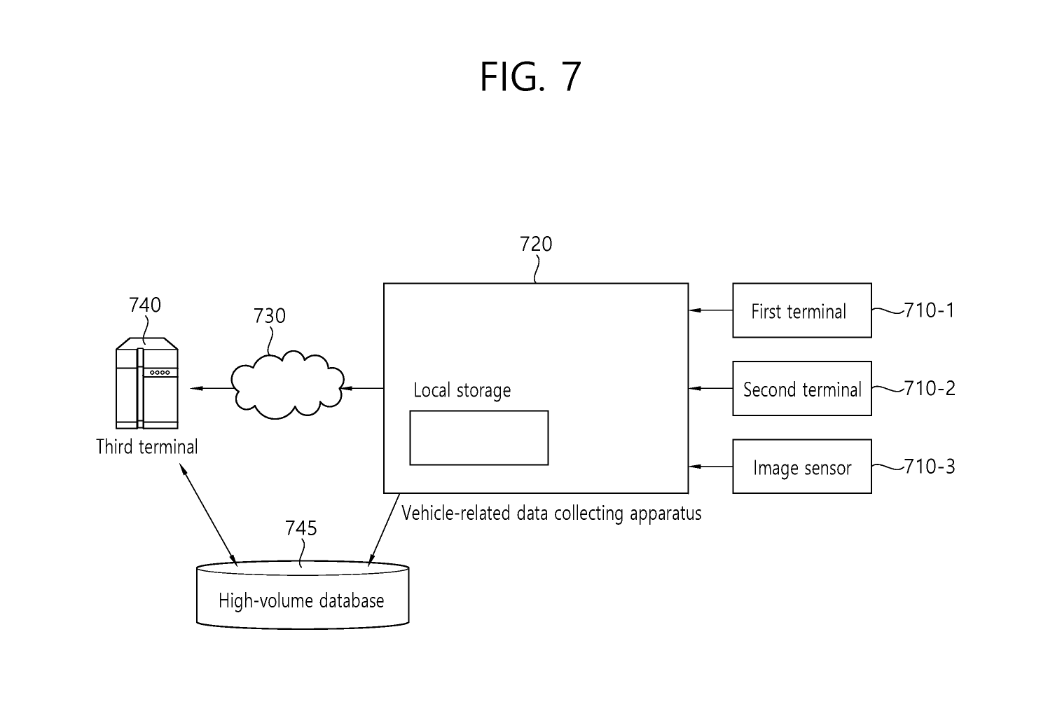

FIG. 7 is a conceptual diagram schematically showing a system for double recording based on a vehicle data collecting apparatus according to another exemplary embodiment of the present invention. As shown in FIG. 7, the system for double recording based on a vehicle data collecting apparatus according to an exemplary embodiment of the present invention may include a first terminal 710-1, a second terminal 710-2, an image sensor 710-3, a vehicle data collecting apparatus 720, a network 730, and a third terminal 740.

Referring to FIG. 7, the vehicle data collecting apparatus 720 may be configured to relay data received from image data provision devices 710-1 to 710-3 to the third terminal 740 and allow the third terminal 740 to record it in real time or output it on the screen. The vehicle data collecting apparatus 720 may receive video in real time, provide the received video to the third terminal 740, and periodically receive reports related to reception from the third terminal 740 to check if there is anything wrong with data reception. Then, if the vehicle data collecting apparatus 720 becomes unable to receive, it may detect the point at which data reception becomes unavailable and record data from that point so as to eliminate a recording or reception interruption caused by a recovery delay.

The vehicle data collecting apparatus 720 may receive a remote video relay request from the third terminal 740 and perform a relay operation. The vehicle data collecting apparatus 720 may receive video from the image data provision devices 710-1 to 710-3 and buffer the received video in a queue for a given amount of time (e.g., a minimum of 15 seconds or so for failure recovery). Afterwards, along with buffering, the vehicle data collecting apparatus 720 may relay video streams and/or other types of data to the third terminal 740 via the network 730.

The network 730 may include short-range communication protocols such as WiFi, ZigBee, and/or Bluetooth, as well as broadband communication protocols such as 2G, 3G, and LTE (Long Term Evolution).

According to an exemplary embodiment of the present invention, the vehicle data collecting apparatus 720 is an apparatus equipped with a recording function and communication and relay functions, which may include a VCR (Video Cassette Recorder), DVR (Digital Video Recorder), PVR (Personal Video Recorder), PC, personal digital assistant (PDA), smartphone, laptop, netbook, consumer electronic (CE) device, player appliance with a wireless communication function, internet appliance, set-top box, etc.

The third terminal 740 may record a video stream received from the vehicle data collecting apparatus 720. The third terminal 740 may create a status report message containing information about whether recording is currently available and/or whether recording is being done normally and transmit it to the vehicle data collecting apparatus 720. If the third terminal 740 becomes unable to record (for example, due to a network failure or recording failure), the vehicle data collecting apparatus 720 may sense this since there has been no status report for a given amount of time. At this point, the vehicle data collecting apparatus 720 may retrieve a paused spot from the queue with respect to a non-response point and resume the recording from that spot.

The third terminal 740 is a device directly connected to the vehicle data collecting apparatus 720 and equipped with a recording function. The third terminal 740, like the vehicle data collecting apparatus 720, may include a VCR, DVR, PVR, and various kinds of computing devices and/or terminals. The third terminal 740 may work in conjunction with a high-volume database 745 and store data received from the vehicle data collecting apparatus 720 in the high-volume database 745.

According to the exemplary embodiment of the present invention, the vehicle data collecting apparatus 720 and the third terminal 740 may record a video stream in conjunction with a common database 745. At this point, the vehicle data collecting apparatus 720 may retrieve the spot at which the recording by the third terminal 740 is paused, based on the video stream recorded in the common database 745, and may record the video stream buffered in the queue in the common database 745 from that spot. Thus, seamlessly recorded video may be recorded in the common database without any operation.

According to an exemplary embodiment of the present invention, seamless recording is possible even when a recording failure occurs in the third terminal 740, and recording without converting the original video can be done by a low-specification device (e.g., desktop) alone.

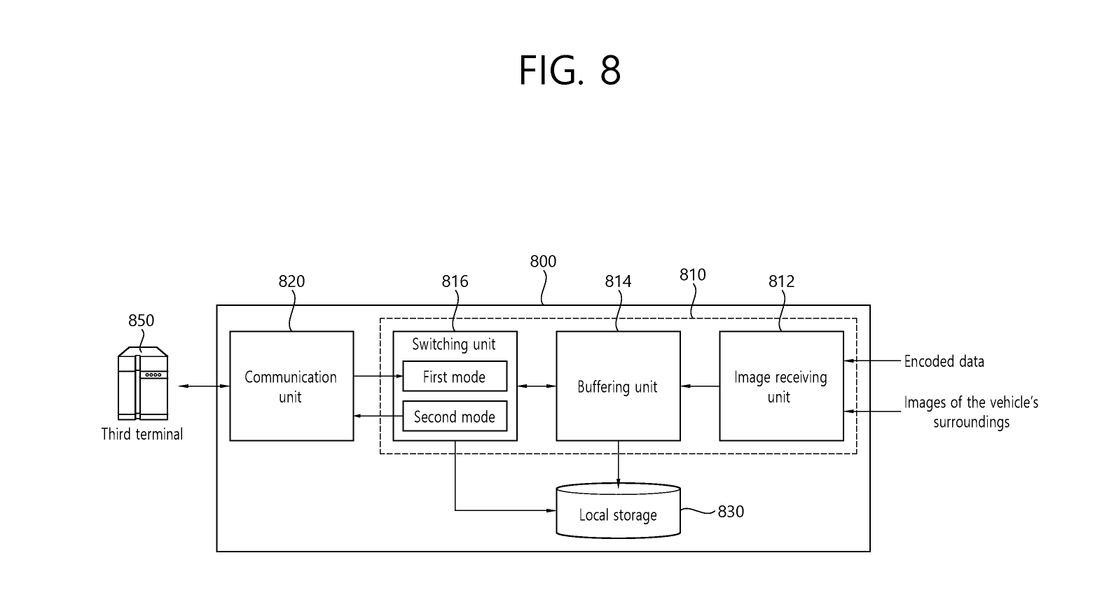

FIG. 8 is a detailed block diagram showing in detail the configuration of a vehicle data collecting apparatus for performing double recording according to another exemplary embodiment of the present invention. As shown in FIG. 8, the vehicle data collecting apparatus may include a controller 810, a communication unit 820, and local storage 830.

Furthermore, the controller 810 may include an image distributor, and may also include an image receiving unit 812, a buffering unit 814, and a switching unit 816. The above components may be implemented by a single hardware process or a plurality of hardware processors, and a plurality of components may be distributed across a plurality of processors. Also, a processor may perform a function based on commands from memory (not shown) including commands for indicating the function of the corresponding component.

Referring to FIG. 8, the image receiving unit 812 may receive a video stream from image provision devices. The image receiving unit 812 performs a function for receiving navigation streaming video encoded in real time by an encoder and other video streams of the vehicle's surroundings. The image receiving unit 812 may include an antenna and/or communication processor. The image receiving unit 812 may receive a video stream in real time and receive a plurality of multiplexed video streams over multiple channels.

The buffering unit 814 may temporarily store the video stream received from the image receiving unit 812 in at least one queue. The maximum buffer time may be set in the buffering unit 814. The maximum buffer time may be set to default, or the user may set the maximum buffer time through a user interface (not shown). The maximum buffer time may be varied during execution of a recording or relay operation. Preferably, the maximum buffer time is longer than the period of receipt of a status report from the third terminal 850. In response to a control signal from the switching unit 816, the buffering unit 814 may store the video stream buffered in a queue in the local storage 830, starting from a specific portion (or specific frame).

The switching unit 816 may receive a video stream from the buffering unit 814 and/or image receiving unit 812 and provide it to the communication unit 820 or local storage 830. The mode in which video streams are provided to the communication unit 820 may be defined as a first mode (or relay mode), and the mode in which video streams are provided to the local storage 830 may be defined as a second mode (or recording mode). In some cases, relaying and recording may be done simultaneously. However, in other exemplary embodiments of the present invention, it is assumed that one of these modes is selected and used.

The switching unit 816 may be configured to operate in the first mode by default. In the first mode, it is assumed that recording is done normally by the third terminal 850, and a video stream received through the buffering unit 814 and/or image receiving unit 812 is relayed to the third terminal 850.

The switching unit 816 may obtain information about whether recording is currently being done normally or not by checking whether the third terminal 850 is recording properly, based on a status report message from the third terminal 850 delivered by the communication unit 820. For example, upon detecting a recording failure situation where recording is not done normally, the switching unit 816 may switch the operation mode from the first mode to the second mode. Regarding the detection of a recording failure situation, the switching unit 816 may compare the time it takes to receive a status report from the third terminal 850 to a preset threshold time, and, if no status report is received for that threshold time or longer, may determine that a recording failure has occurred. The maximum buffer time may be set as the threshold time. Alternatively, the switching unit 816 may determine the occurrence of a recording failure situation according to according to threshold conditions. The threshold conditions may include a condition in which a status report delay (e.g., the period of time during which no status report has been received, from the time of receipt of the most recent status report until the present time) is longer than the average time it takes to receive a status report, and/or a condition in which the status report delay is longer than half the maximum buffer time. If the above threshold conditions are met, it is determined that the connection with the third terminal 850 is released or the third terminal 850 is incapable of recording, and the switching unit 816 switches to the second mode in which the vehicle data collecting apparatus 800 itself records a video stream. In the second mode, the switching unit 425 allows a video stream to be stored directly in the storage unit 429. The switching unit 816 receives a stream buffered by the buffering unit 814 and provides it to the local storage 830, or may give an instruction to the buffering unit 814 to allow the buffering unit 814 to store a video stream directly in the local storage 830. In this case, it is assumed that the third terminal 850 has not recorded any video stream after a non-response point, and may find the non-response point and store the video stored in a queue of the buffering unit 814 in the local storage 830 from that point.

When the third terminal 850 resumes reporting, then the switching unit 816 switches from the second mode to the first mode at a point in time when it receives a status report again to allow the third terminal 850 to record the video stream and allow itself to serve as a relay.

The communication unit 820 provides a connection with the third terminal 850. The connection may be made through a wired or wireless network. The communication unit 820 may be a modem, antenna, modem for communication, and/or communication processor. Thus, the communication unit 820 may send and receive various information including video streams to and from the third terminal 850. If the switching unit 816 is in the first mode, the communication unit 820 may deliver a video stream to the third terminal 850. The communication unit 820 may periodically receive status reports form the third terminal 850 and provide them to the switching unit 816.

In the second mode, the local storage 830 may receive a buffered video stream from the switching unit 816 or buffering unit 814 and store it in an internal memory (not shown) and/or a database (not shown). The internal memory may be a hard disk, flash disk, or RAM/ROM which resides in the vehicle data collecting apparatus 800.

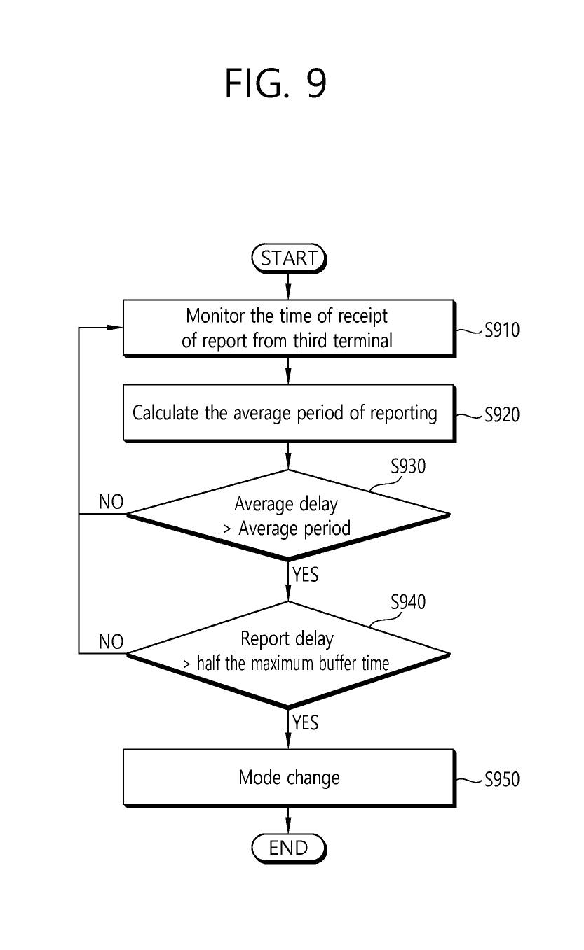

FIG. 9 is a flowchart showing a method for determining whether a failure has occurred by the switching unit of FIG. 8.

Referring to FIG. 9, a switching unit of the vehicle data collecting apparatus may receive and monitor status report messages from a worker through a communication unit (S910).

Afterwards, the switching unit may store a certain volume of information about the time of receipt of a status report message from a third terminal. The average period of reporting may be calculated based on this information (S920).

Based on status report message monitoring results and information about the average period of receipt of a report message, the switching unit may determine whether a failure has occurred or not, according to the following switching conditions (or threshold conditions):

### Switching Conditions

Rₜ=Time of receipt of status report message from the third terminal

Bₘ=Set maximum buffer time

Vₜ=Average period of Rt

Tₙ=Measured delay from Rₜ

(i) For Vt<Tₙ && (ii) Tₙ>(Bₘ/2), perform switching.

According to the switching conditions, the switching unit measures the delay Tₙ from the time of receipt of a status report message and determines whether the measured delay is longer than the average period Vₜ (S930). And/or, if the measured delay Tₙ is longer than half the maximum buffer time Bₘ, the switching unit may determine that a recording failure has occurred (S940). In this instance, the delay may be calculated with respect to a non-response point. Moreover, the switching conditions are not always set with respect to half the maximum buffer time Bₘ, but may be set with respect to a user-set time, the maximum buffer time Bₘ, and/or a new reference time, which is calculated by subtracting a certain length of time from the maximum buffer time Bₘ. The switching conditions may be set as the user desires through a user interface.

Hereupon, the switching unit may detect the occurrence of a failure and provide a control signal to indicate mode change (S950). At the same time, a control signal may be provided to a buffering unit to find the non-response point (e.g., the time of receipt of the most recent status report signal) and store a buffered video stream from that point.

Moreover, if status reporting is resumed at a point during the second mode, that is, while a failure is occurring, the switching unit may determine that a status report is received again at that point. In this instance, the switching unit may generate a control signal to direct the switching unit to change the mode from the second mode to the first mode.

As described previously, in the first mode, a buffered video stream is transmitted to the third terminal via the communication unit. On the contrary, in the second mode, the buffered video stream is transmitted to local storage. If a switching indication control signal is received in the first mode, the operation mode may be switched to the second mode, and if a switching indication control signal is received in the second mode, the operation mode may be switched to the first mode.

According to a vehicle-related collecting apparatus and method of the present invention, operation information and data as well as images of a vehicle-moving environment may be efficiently managed by obtaining and encoding streaming video data related to the vehicle's operation and synchronizing and storing different forms of vehicle operation data and image data of the vehicle's surroundings based on time information, and efficient real-time transmission to an external terminal may be achieved.

While the invention has been described with reference to the drawings and embodiments, the description is illustrative and is not to be construed as limiting the protection scope of the invention. Those skilled in the art will understand that various modifications and changes may be made without departing from the spirit and scope of the invention as defined by the appended claims.

What is claimed is:

1. A method for collecting vehicle-related data, comprising:
obtaining navigation streaming video data related to a vehicle operation and vehicle operation information, from a first terminal handling vehicle operation information;
encoding in real time the navigation streaming video data, which is received from the first terminal via a wired or wireless network, by an encoder; and
synchronizing and storing the real-time encoded navigation streaming video data and the vehicle operation information based on time information.

2. The method of claim 1, further comprising obtaining image data of the vehicle's surroundings from a second terminal capturing the vehicle's surroundings,
wherein the storing comprises synchronizing and storing the streaming video data, the vehicle operation information, and the image data of the vehicle's surroundings based on time information.

3. The method of claim 2, further comprising transmitting the real-time encoded navigation streaming video data, the vehicle operation information, and the image data of the vehicle's surroundings in real time to a third terminal external to the vehicle.

4. The method of claim 3, wherein the transmitting of the real-time encoded navigation streaming video data, the vehicle operation information, and the image data of the vehicle's surroundings in real time to the third terminal comprises:
obtaining image output condition information which is related to the real-time encoded navigation streaming video data and the image data of the vehicle's surroundings;
adjusting the resolution of the real-time encoded navigation streaming video data and the resolution of the image data of the vehicle's surroundings based on the obtained image output condition information; and
transmitting the real-time encoded navigation streaming video data and the image data of the vehicle's surroundings with the adjusted resolutions to the third terminal.

5. The method of claim 4, wherein the adjusting resolution of the real-time encoded navigation streaming video data and the resolution of the image data of the vehicle's surroundings based on the obtained image output condition information comprises determining the resolution of the real-time encoded navigation streaming video data and the resolution of the image data of the vehicle's surroundings in a way as to keep the bandwidth for data transmission to the third terminal to a minimum, while maintaining a first reference resolution for the navigation streaming video data encoded in real time by the encoder and a second reference resolution for the image data of the vehicle's surroundings in the image output conditions.

6. The method of claim 3, wherein the synchronizing and storing of the navigation streaming video data, the vehicle operation information, and the image data of the vehicle's surroundings based on time information comprises:
partially storing the real-time encoded navigation streaming data, the vehicle operation information, and the image data of the vehicle's surroundings in a queue;
relaying the real-time encoded navigation streaming video data, the vehicle operation information, and the image data of the vehicle's surroundings to the third terminal; and
switching the operation mode between a relay mode and a recording mode, the relay mode being a mode in which the real-time encoded navigation streaming data, the vehicle operation information, and the image data of the vehicle's surroundings are relayed to the third terminal based on status reports periodically received from the third terminal, and the recording mode being a mode in which the real-time encoded navigation streaming data, the vehicle operation information, and the image data of the vehicle's surroundings are stored in local storage.

7. The method of claim 6, wherein the switching of the operation mode comprises switching the operation mode such that the real-time encoded navigation streaming data, the vehicle operation information, and the image data of the vehicle's surroundings, which are buffered in a queue with respect to a non-response point after which there is no status report from the third terminal, are stored in the local storage.

8. The method of claim 6, wherein the switching of the operation mode comprises:
periodically receiving status reports from the third terminal;
calculating the average time it takes to receive a report by measuring the time of receipt of a report from the third terminal;
determining whether a recording failure has occurred or not by comparing the time it takes to receive a status report from the third terminal to a threshold time; and
switching to the relay mode or the recording mode based on the result of determination,
wherein the determination of whether a failure has occurred is based on a status report delay which is measured by taking into account either one or both of the measured average time to receive a report and the maximum buffer time.

9. The method of claim 1, wherein the first terminal comprises a navigation terminal, and the second terminal comprises a black box terminal.

10. The method of claim 1, further comprising obtaining assistance image data related to vehicle parking from an image sensor,
wherein the navigation streaming video data, the vehicle operation information, the image data of the vehicle's surroundings, and the assistance image data are synchronized and stored based on time information.

11. An apparatus for collecting vehicle-related data, comprising:
an encoder that obtains navigation streaming video data related to a vehicle operation and vehicle operation information from a first terminal handling vehicle operation information via a wired or wireless network and encodes the navigation streaming video data in real time;
a controller that performs control functions for synchronizing the real-time encoded navigation streaming video data and the vehicle operation information based on time information and storing the same in local storage; and
local storage that stores the real-time encoded navigation streaming video data and the vehicle operation information.

12. The apparatus of claim 11, wherein the controller obtains image data of the vehicle's surroundings from a second terminal capturing the vehicle's surroundings,
wherein the controller synchronizes the streaming video data, the data related to the vehicle's operation, and the image data of the vehicle's surroundings based on time information and stores the same in the local storage.

13. The apparatus of claim 12, further comprising a communication unit for transmitting the real-time encoded navigation streaming video data, the vehicle operation information, and the image data of the vehicle's surroundings in real time to a third terminal external to the vehicle.

14. The apparatus of claim 13, wherein the controller performs control functions for:
obtaining image output condition information which is related to the real-time encoded navigation streaming video data and the image data of the vehicle's surroundings;
adjusting the resolution of the real-time encoded navigation streaming video data and the resolution of the image data of the vehicle's surroundings based on the obtained image output condition information; and
transmitting the real-time encoded navigation streaming video data and the image data of the vehicle's surroundings with the adjusted resolutions to the third terminal.

15. The apparatus of claim 14, wherein the controller determines the resolution of the real-time encoded navigation streaming video data and the resolution of the image data of the vehicle's surroundings in a way as to keep the bandwidth for data transmission to the third terminal to a minimum, while maintaining a first reference resolution for the navigation streaming video data encoded in real time by the encoder and a second reference resolution for the image data of the vehicle's surroundings in the image output conditions.

16. The apparatus of claim 13, wherein the controller performs control functions for:
partially storing the real-time encoded navigation streaming data, the vehicle operation information, and the image data of the vehicle's surroundings in a queue;
relaying the real-time encoded navigation streaming video data, the vehicle operation information, and the image data of the vehicle's surroundings to the third terminal; and
switching the operation mode between a relay mode and a recording mode, the relay mode being a mode in which the real-time encoded navigation streaming data, the vehicle operation information, and the image data of the vehicle's surroundings are relayed to the third terminal based on status reports periodically received from the third terminal, and the recording mode being a mode in which the real-time encoded navigation streaming data, the vehicle operation information, and the image data of the vehicle's surroundings are stored in local storage.

17. The apparatus of claim 16, wherein the controller performs control functions for switching the operation mode such that the real-time encoded navigation streaming data, the vehicle operation information, and the image data of the vehicle's surroundings, which are buffered in a queue with respect to a non-response point after which there is no status report from the third terminal, are stored in the local storage.

18. The apparatus of claim 16, wherein the switching of the operation mode by the controller is done by periodically receiving status reports from the third terminal, calculating the average time it takes to receive a report by measuring the time of receipt of a report from the third terminal, determining whether a recording failure has occurred or not by comparing the time it takes to receive a status report from the third terminal to a threshold time, and switching to the relay mode or the recording mode based on the result of determination,
wherein the determination of whether a failure has occurred is based on a status report delay which is measured by taking into account either one or both of the measured average time it takes to receive a report and the maximum buffer time.

19. The apparatus of claim 11, wherein the controller obtains assistance image data related to vehicle parking from an image sensor,
wherein the navigation streaming video data, the vehicle operation information, the image data of the vehicle's surroundings, and the assistance image data are synchronized and stored based on time information.

20. A system for collecting vehicle-related data, comprising:
a vehicle-related data collecting apparatus that obtains navigation streaming video data related to a vehicle operation and vehicle operation information from a first terminal handling vehicle operation information, encodes in real time the navigation streaming video data, which is received from the first terminal, and synchronizes the real-time encoded navigation streaming video data and vehicle operation information based on time information and transmits the same to a third terminal external to the vehicle; and
a third terminal that receives the real-time encoded navigation streaming video data and the vehicle operation information from the vehicle-related data collecting apparatus and stores the same.
